(19) United States
(12) Patent Application Publication
(10) Pub. No.: US 2002/0083010 A1
(43) Pub. Date: Jun. 27, 2002

(54) Electronic identification system

(76) Inventor: Namsuk Kim, Shoreline, WA (US)

Correspondence Address: LONG ALDRIDGE & NORMAN LLP, 701 Pennsylvania Avenue, N.W., Suite 600, Washington, DC, 20004, US

(21) Appl. No.: 10/003,429

(22) Filed: Dec. 6, 2001

Related U.S. Application Data
(60) Provisional application No. 60/254,095, filed on Dec. 11, 2000.

(51) Int. Cl. G06F 17/60

(52) U.S. Cl. 705/64

(57) ABSTRACT

A method of authenticating in a network-based transaction includes receiving a transaction request from a first party; requesting client identification by a second party, receiving a first authorization code of the first party for authentication by the second party, submitting a second authorization code of the second party and the first authorization code of the first party to an electronic identification system for verifying the first and second authorization codes, and sending specific information of the first party to the second party via the second party's electronic form.

This application claims the benefit of U.S. Provisional Patent Application No. 60/254,095, filed on Dec. 11, 2000, which is hereby incorporated by reference for all purposes as if fully set forth herein.

### BACKGROUND OF THE INVENTION

1. Field of the Invention

The present invention relates a system and method for storage, retrieval, and delivery of client-specific information in network-based transactions within the Internet, wireless communication, telecommunication, and other interactive environments.

2. Discussion of the Related Art

Electronic commerce (e-commerce) has become a viable alternative to purchasing goods and services in person at a vendor's place of business. E-commerce has globalized even small businesses by allowing access from clients and potential clients through network connections, both internet and non-internet-based. What once was a neighborhood “Mom and Pop” store is now a nationwide, if not worldwide, supplier of goods or services. It is not even necessary to maintain a “brick and mortar” store location. E-commerce vendors conduct businesses that range from an alternate contact for a retail chain store to a home-based enterprise with no in-person client/vendor interaction possible. The commonality of these vendors is the need for fast, secure, and accurate client information, most specifically regarding payment and shipping options. Vendors also benefit by maintaining records of client purchases and spending habits that are not always available in a retail store transaction. The difficulty of e-commerce purchasing has evolved along with the availability of goods and services for the following reasons:

a) large numbers of individual vendors are vying for the same client base;

b) vendors need additional client information that was not traditionally needed for in-person retail contact (i.e. name, billing address, shipping address, preferred delivery method, alternate addresses for gift deliveries, etc. . . . );

c) clients are reluctant to spend the necessary time to complete or change this information for each and every vendor from which a purchase is initiated,

d) clients are frustrated by multiple user-id's and possible multiple passwords that they must maintain to transact business with vendors; and

e) clients are restricted by currently available E-commerce companions when using network access devices other than their own (i.e. a hotel's Internet kiosk versus their own personal computer) because of the need to download the companion software again and reenter client information in the temporary network access device (current E-commerce companion software requires client information to be kept on the client's network access device).

Clients or customers, therefore, are less likely to choose network-based purchasing over in-person retail transactions. When the clients do initiate network vendor contact, they tend to return to the same vendors where they have existing accounts, thereby, potentially losing the competitive pricing edge of network shopping. Impulsive purchases, especially from new vendors, are less probable because of the tedious electronic forms required by each vendor. Some researches suggest that up to 40% of all transactions are aborted at the electronic checkout stage due to this need for electronic data exchange. Existing user-id's and passwords can also be lost or forgotten by clients, which would necessitate another new account creation, or at the very least, a secondary verification procedure to reissue a password for the existing account. Clients who are away from their regular network access device (i.e. personal computer) may find it difficult to complete e-commerce transactions on other available devices, such as a friend's personal computer. These difficulties arise because of differing operating systems, the need for particular e-commerce companion software to be downloaded onto the device, and the necessity of reentering their information for the companion software that is kept on the individual device.

FIG. 1 illustrates the current e-commerce model of a client and vendor relationship, in which the client is the service seeker and the vendor is the service provider.

FIG. 2 is a process model or flowchart of the client/vendor relationship outlined in FIG. 1. The contact is initiated by the client who is seeking a service or product from a vendor through a network-accessible device (step 200). The client must then proceed with the purchase of these goods or services from the vendor through an electronic checkout procedure (step 202). The vendor must then determine the identity of the client (step 204) and establish an account (step 212), if one does not already exist. An established client, i.e. one that has previously created an account with this vendor, responds with a vendor-specific user-id and password for authentication (step 206). The vendor verifies the client's identity and displays default account information for approval or correction (step 208). As necessary, the client makes changes in an electronic form format and submits correct account information for transaction completion (step 210). If the client needs an account established, i.e. is a new client for the vendor, then the client must choose a vendor-specific user-id and a password, both of which must be approved by the vendor, to begin the account creation process (step 212). The vendor opens a new account and requests client-specific transaction information via an electronic form (step 214). This information will become the default account information for that client. When completed, the form is submitted by the client for transaction completion (step 216). In both the established client and new client cases, the vendor confirms the submitted client information with the client and processes the purchase of goods or services (step 218).

### SUMMARY OF THE INVENTION

Accordingly, the present invention is directed to an electronic identification system that substantially obviates one or more of the problems due to limitations and disadvantages of the related art.

An advantage of the present invention is to provide an electronic identification system to facilitate data exchange transactions and promote network-based transactions between clients and vendors.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method of authenticating in a network-based transaction comprises receiving a transaction request from a first party; requesting client identification by a second party; receiving a first authorization code of the first party for authentication by the second party; submitting a second authorization code of the second party and the first authorization code of the first party to an electronic identification system for verifying the first and second authorization codes; and sending specific information of the first party to the second party via the second party's electronic form.

It is to be understood that both the foregoing general description and the following detailed description are exemplary and explanatory and are intended to provide further explanation of the invention as claimed.

### BRIEF DESCRIPTION OF THE DRAWING

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a conventional e-commerce model;

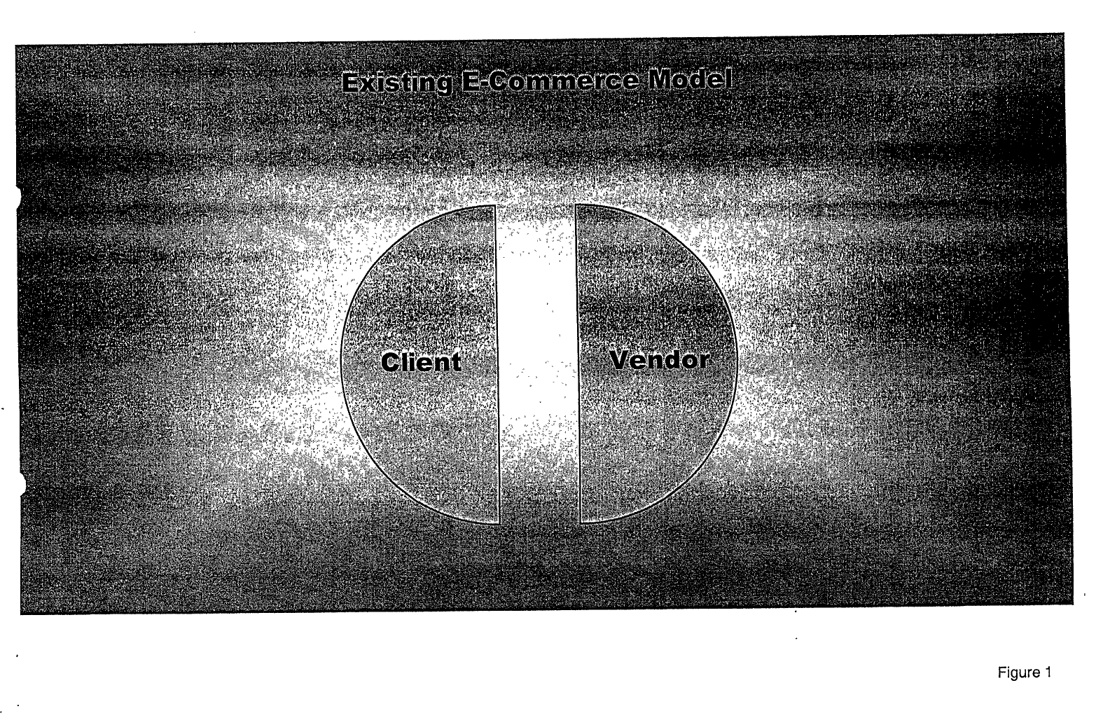

FIG. 2 illustrates a flowchart for the conventional e-commerce model;

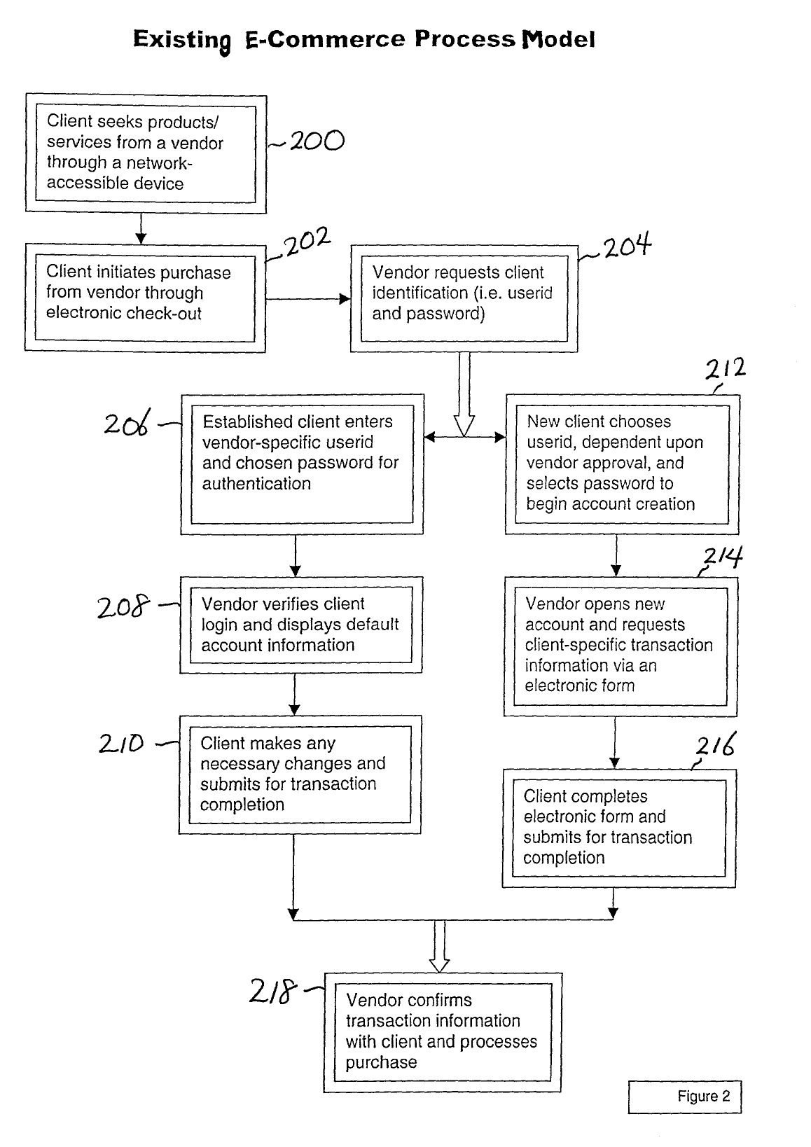

FIG. 3 illustrates an electronic identification system e-commerce model according to the principles of the present invention; and

FIG. 4 illustrates a flowchart for the electronic identification system e-commerce model according to the principles of the present invention.

### DETAILED DESCRIPTION OF THE ILLUSTRATED EMBODIMENTS

Reference will now be made in detail to an embodiment of the present invention, example of which is illustrated in the accompanying drawings.

The present invention provides an electronic identification system, based upon a central repository, which automates client-specific data entry to network-based application input forms within various electronic environments. The electronic identification system utilizes a single, unique client (i.e. service seeker) identification name and secure password to grant access for automation of third party vendor (i.e. service provider) electronic data exchange. The client identification file is housed in a secure central server and is accessible from any network-based communications device, including but not limited to the Internet, telecommunications devices, wireless communication devices, and remote network access points (i.e. kiosks). This access, controlled by a secure client password and authentication code, is independent of client or vendor operating systems, applications software, or network access location. The central repository of client information contains compartmentalized files primarily for electronic commerce transactions (e-commerce) and secondarily for personal, medical, employment, and other information as initiated by each client. The electronic identification system with the central information repository is designed to facilitate data exchange transactions and promote network-based transactions between clients and vendors by eliminating cumbersome systems of multiple client user-id's and/or passwords and transaction form completions.

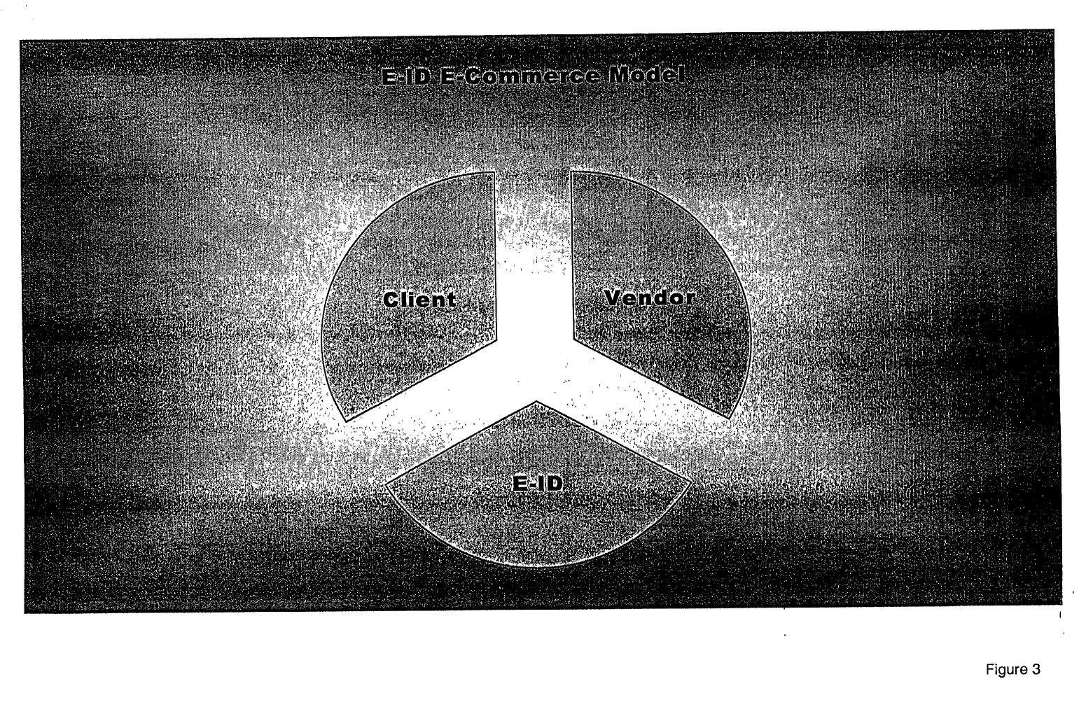

FIG. 3 illustrates the E-ID e-commerce model of a client, vendor, and electronic identification repository relationship, in which the client is still the service seeker, the vendor is still the service provider, and the electronic identification repository is the agent for both transaction participants.

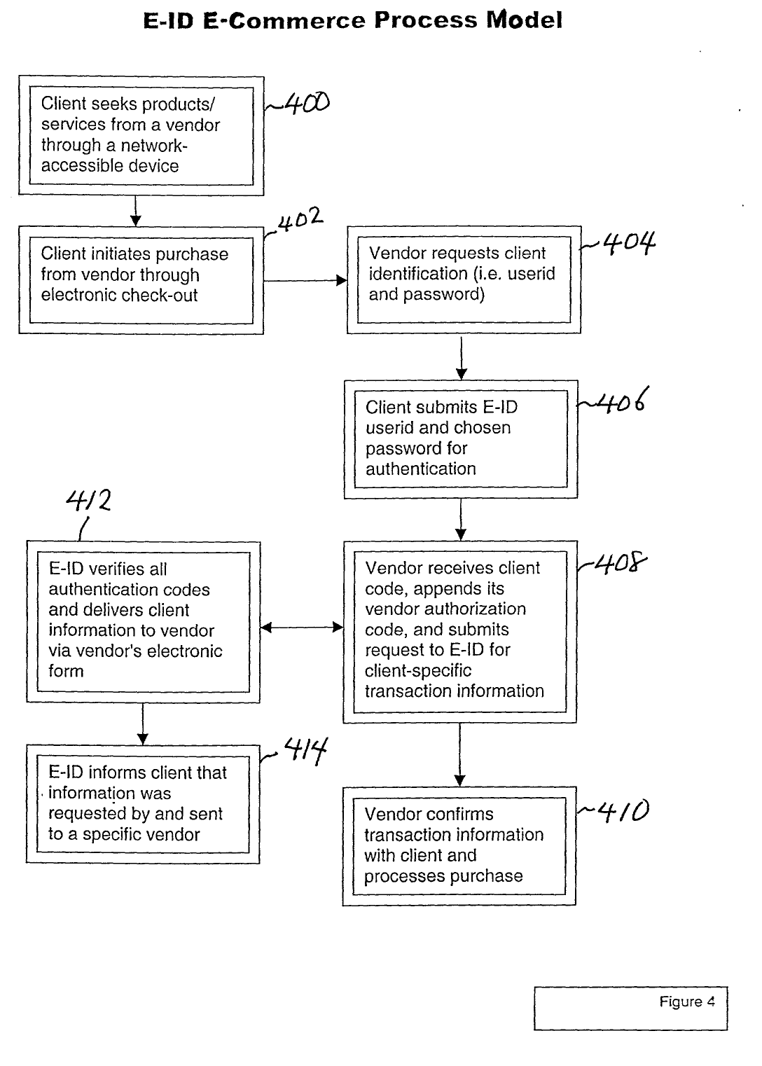

FIG. 4 is a process model or flowchart of the client/vendor/E-ID relationship outlined in FIG. 3. The contact is initiated by the client who is seeking a service or product from a vendor through a network-accessible device (step 400). The client must then proceed with the purchase of these goods or services from the vendor through an electronic checkout procedure (step 402). The vendor must then determine the identity of the client (step 404) and establish an account, if one does not already exist. The client, regardless of previous status with the vendor, submits its E-ID information to the vendor for identity authentication (step 406). The vendor receives the client authentication code, appends its own vendor authorization code, and submits the request for information to the E-ID repository (step 408). The E-ID repository verifies all authentication codes and delivers client information to the vendor via the vendor's electronic form (step 412). The E-ID repository also informs the client that information was requested by and sent to the vendor (step 414). The vendor confirms transaction information with the client and processes the purchase of goods or services (step 410).

Although the present invention has been described with respect to a client and vendor, other applications are also contemplated where personal information needs to be entered such as transactions between (1) a patient and a hospital or dental office (e.g., health history), (2)a client and a bank, (3) a client and an insurance office, (4) a mileage program for an airline, and (5) credit card applications.

It will be apparent to those skilled in the art that various modifications and variation can be made in the electronic identification system of the present invention without departing from the spirit or scope of the invention. Thus, it is intended that the present invention cover the modifications and variations of this invention provided they come within the scope of the appended claims and their equivalents.

What is claimed is:

1. A method of authenticating in a network-based transaction comprising:
receiving a transaction request from a first party;
requesting client identification by a second party;
receiving a first authorization code of the first party for authentication by the second party;
submitting a second authorization code of the second party and the first authorization code of the first party to an electronic identification system for verifying the first and second authorization codes; and
sending specific information of the first party to the second party via an electronic form of the second party.

2. The method of authenticating in a network-based transaction according to claim 1, further comprising informing the first party that the specific information was requested by and sent to the second party.

3. The method of authenticating in a network-based transaction according to claim 1, further comprising:
the second party confirming transaction information with the first party; and
processing the transaction.

4. The method of authenticating in a network-based transaction according to claim 1, wherein the first party is a client and the second party is a vendor.

5. The method of authenticating in a network-based transaction according to claim 1, wherein the first party is a patient and the second party is a hospital.

6. The method of authenticating in a network-based transaction according to claim 1, wherein the first party is a patient and the second party is a dental office.

7. The method of authenticating in a network-based transaction according to claim 1, wherein the first party is a client and the second party is a mileage program for an airline.

8. The method of authenticating in a network-based transaction according to claim 1, wherein the first party is a client and the second party is a bank.

9. The method of authenticating in a network-based transaction according to claim 1, wherein the first party is a credit card applicant and the second party is a credit card company.

10. A method of authenticating in a network-based transaction comprising:
receiving a transaction request from a first party;
requesting client identification by a second party;
receiving a first authorization code of the first party for authentication by the second party;
submitting a second authorization code of the second party and the first authorization code of the first party to an electronic identification system for verifying the first and second authorization codes;
sending specific information of the first party to the second party via an electronic form of the second party;
informing the first party that the specific information was requested by and sent to the second party;
the second party confirming transaction information with the first party; and
processing the transaction.
